(19) United States
(12) Patent Application Publication
(10) Pub. No.: US 2004/0179657 A1
(43) Pub. Date: Sep. 16, 2004

(54) Method and system for visual notification of the status of a user's messaging unit

(76) Inventor: Luc Vacquie, Saint Jean L'Herm (FR)

Correspondence Address: YOUNG & THOMPSON, 745 SOUTH 23RD STREET 2ND FLOOR, ARLINGTON, VA, 22202

(21) Appl. No.: 10/478,355

(22) PCT Filed: May 16, 2002
(86) PCT No.: PCT/FR02/01662

(30) Foreign Application Priority Data
May 23, 2001 (FR) 01/06839

(51) Int. Cl. H04M 1/64; H04M 11/00

(52) U.S. Cl. 379/88.11; 379/93.17

(57) ABSTRACT

The invention concerns a system for visual notification of the status of a user's messaging unit characterised in that it comprises means (1) monitoring the messaging unit connected to various means (5, 6, 7) for receiving messages addressed to the user; means (8) for analysing said messages and their characteristics; means (11) for generating a pictogram with modifiable attributes under the control of the analysing means, based on the result of the analysis of the messages or of their characteristics; and means for controlling (14) means displaying (15, 16, 17, 18, 19) said generated pictogram to the user to notify him of the status of the messaging unit.

The present invention relates to a method and a system for visual notification of the state of a user's messaging unit.

Notification systems of this type already exist in the prior art, which systems are associated, for example, with means for monitoring an e-mail box associated with a user and are thus suitable for warning the user when a message arrives.

Notification systems of this type are also included, for example, in telephone answering machines in order to indicate that messages have been recorded therein.

On detecting such notifications, the user is led to consult the messages.

Nevertheless, it will be understood that such operations are relatively inconvenient since the user needs to consult the various message-receiving means available to the user one after another, and needs to consult all of the messages contained in each of them one after another.

This becomes more and more troublesome with the increasing number of communications means now available.

The object of the invention is thus to solve these problems.

To this end, the invention provides a method of visually notifying the state of a user's messaging unit, the method being characterized in that it comprises the following steps:

monitoring the messaging unit, by monitoring the various means for receiving messages destined for the user;

analyzing the messages and their characteristics;

generating a pictogram having attributes that are modifiable as a function of the result of analyzing the messages and their characteristics; and

presenting said generated pictogram to the user in order to notify the user of the state of the messaging unit.

In another aspect, the invention also provides a system for visually notifying the state of the messaging unit of a user, the system being characterized in that it comprises:

means for monitoring the messaging unit, being connected to the various means for receiving messages destined to the user;

analysis means for analyzing the messages and their characteristics;

means for generating a pictogram having attributes that are modifiable under the control of the analysis means as a function of the result of the analysis of the messages and their characteristics; and

control means for controlling means for presenting said generated pictogram to the user to notify the user of the state of the messaging unit.

The invention will be better understood on reading the following description given purely by way of example and made with reference to the accompanying drawings, in which:

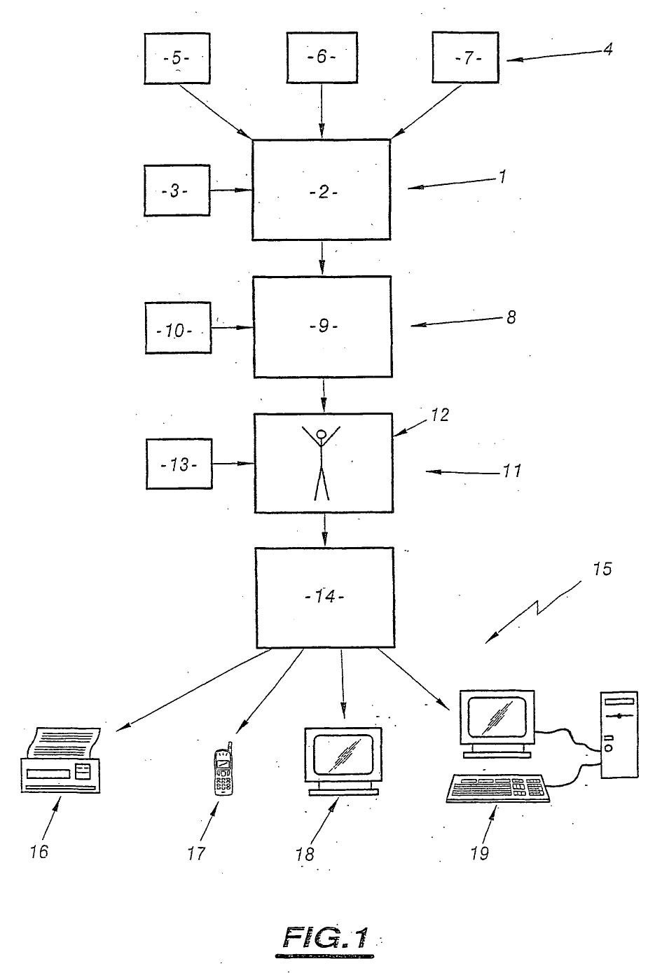

FIG. 1 is a block diagram showing the general structure of a system of the invention;

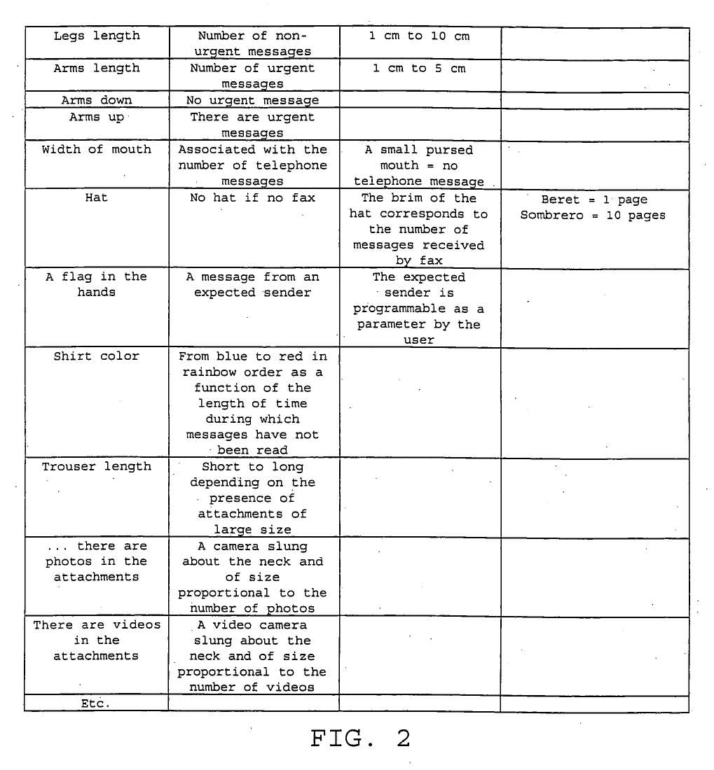

FIG. 2 is a table showing an example of how a pictogram is generated; and

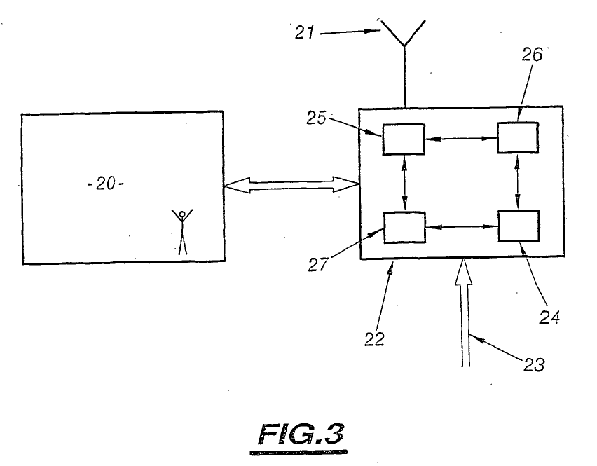

FIG. 3 is a block diagram showing such a system associated with a TV set.

FIG. 1 shows a system for visually notifying the state of a user's messaging unit.

The system comprises means for monitoring the messaging unit which means are given overall reference 1 in this figure and comprise, for example, a data processor unit given overall reference 2 associated with data storage means given overall reference 3.

These monitoring means are connected to various means for receiving messages destined for the user in order to monitor them.

These means are given overall reference 4 in FIG. 1 and comprise, for example, means of different kinds that enable messages of different kinds to be received by the user.

By way of example, these means comprise an e-mail box given overall reference 5, a telephone answering machine given overall reference 6, and a fax-receiving system given overall reference 7, etc. . . .

These monitoring means 1 are connected to means for analyzing the messages and their characteristics, these analysis means being given overall reference 8 in this figure.

These means also comprise a data processor unit given an overall reference 9 and data storage means given overall reference 10.

These analysis means are connected to means 11 for generating a pictogram having attributes that are modifiable under the control of the analysis means as a function of the results of analyzing messages and their characteristics.

These means likewise comprise a data processor unit 12 associated with data storage means 13.

These generator means are also connected to control means 14 for controlling means that show the generated pictogram to the user in order to inform the user about the state of the messaging unit.

The presentation means are given overall reference 15 in the figure and may likewise comprise means of different kinds.

Thus, for example, these presentation means may comprise means for printing the pictogram designated by overall reference 16, comprising a suitable printer or fax machine, a mobile telephone 17, a TV set 18, or a microcomputer 19.

The system of the invention serves to inform the user of the state of the messaging unit associated therewith by means of a representation in the form of a single pictogram that is easily analyzed and perceived by the user, the state comprising in particular the number, the kind, and the importance of the messages sent to the user, together with various characteristics thereof, such as the sender of a message, its size, the number of attachments, etc. . . .

By generating a pictogram whose attributes are established as a function of the analysis of the messages and their characteristics, it is possible for the state of the messaging unit to be summarized in graphic form and shown to the user in such a manner as to enable the user to assess said state at a glance.

On the basis of this presentation, the user can then decide whether or not to consult such and such a message, or such and such a corresponding means for receiving messages.

The analysis means are thus adapted to scan the various still-unread messages in the various corresponding message-receiving means in order to draw up a table, e.g. in a database associated with its data storage means, the table containing the various messages classified by size, sender, urgency, presence or absence of the sender in an address book, i.e. whether the message comes from a sender who is known or unknown, and other characteristics.

This process is renewed for each of the means for receiving messages destined to the user, for example e-mail, telephone answering machine, fax receiver, etc.

This database is used by the pictogram generator means to devise the pictogram as a function of the user's wishes, where the user can program wishes in said means, for example.

These generator means then construct a pictogram whose graphical characteristics contain meaningful information illustrating the state of the messaging unit as a function of the previously-drawn up database and as a function of the wishes programmed by the user.

Thus, for example, the user is invited to select a basic pictogram which can be in the form of a figure, for example, or in some other form, together with parameters that will influence modifiable attributes of the figure, so as to inform the user of the results of analyzing the messages and their characteristics.

In order to give an example of such generation of a pictogram, it can be assumed that the pictogram is in the form of a figure having a head, a body, arms, and legs, together with various accessories and garments.

The table of FIG. 2 gives an idea of the attributes of the figure that can be modified to show the results of analyzing messages and their characteristics.

It can be seen that each attribute of this figure may be associated with a specific kind of information to be communicated to the user concerning the state of the messaging unit.

Once the pictogram has been generated with attributes complying with the results of the analysis of the messages and their characteristics, the pictogram is transmitted for presentation to the user, e.g. under the control of control means.

The control means are adapted, for example, to transmit the pictogram to means for presenting the pictogram to the user, which as mentioned above, may be in the form of means for printing the pictogram, means for displaying it on a computer screen, on a TV screen, or on a mobile telephone.

When the pictogram is to be displayed on the screen of a mobile telephone, the control means 14 make a call thereto and transfer a file corresponding to the graphical shape for said telephone so as to enable it to be displayed on the screen of the telephone.

When the pictogram is to be displayed on a TV screen, it may be displayed for a few seconds superposed on a broadcast program.

This is then implemented by means of a system of the kind shown in FIG. 3, for example, where there can be seen a TV set given overall reference 20 associated with a receiving antenna given overall reference 21, connected to a unit given overall reference 22 itself connected to a telephone connection given overall reference 23.

The unit 22 includes a modem given overall reference 24, a system of the invention given overall reference 25, data storage means given overall reference 26, and means for generating a video signal given overall reference 27.

Units analogous to the unit 22 are already known in the state of the art and are associated with a telephone connection and a TV set in order to produce an image of a graphics shape overlaid on the broadcast image on the TV screen, e.g. in a manner similar to a station logo.

The connection between the unit and the TV set can then be provided via a peritel (SCART) socket.

It should also be observed that the analysis means may include additional functions, such as, for example, functions for detecting the arrival of a message expected by the user, which functions can be programmed by the user, e.g. in the data storage means, so as to cause a warning signal to be sent to the user in order to draw the user's attention to the arrival of the expected message.

A warning message may also be generated by the analysis means in order to draw the user's attention to the fact that messages having a degree of urgency have been received or indeed that the messaging unit contains a large number of messages.

These various parameters can also be programmed by the user.

Naturally, still further embodiments of the invention can be envisaged.

Thus, for example, pictograms with modifiable attributes can be used that are presented in forms other than that of a figure.

In addition, pictograms including summaries of messages may also be used in order to form a message that can be sent by fax in order to enable a user to have an overall view of the messaging unit.

Animated pictograms may also be used.

Means for receiving messages other than those described can also be connected to the monitoring means, and for presenting a pictogram to the user can also be envisaged that are different from those described above.

1. A method of visually notifying the state of a user's messaging unit, the method being characterized in that it comprises the following steps:
monitoring the messaging unit, by monitoring the various means for receiving messages destined for the user;
analyzing the messages and their characteristics;
generating a pictogram having attributes that are modifiable as a function of the result of analyzing the messages and their characteristics; and
presenting said generated pictogram to the user in order to notify the user of the state of the messaging unit.

2. A system for visually notifying the state of the messaging unit of a user, the system being characterized in that it comprises:
means (1) for monitoring the messaging unit, being connected to the various means (5, 6, 7) for receiving messages destined to the user;
analysis means (8) for analyzing the messages and their characteristics;
means (11) for generating a pictogram having attributes that are modifiable under the control of the analysis means as a function of the result of the analysis of the messages and their characteristics; and
control means (14) for controlling means (15, 16, 17, 18, 19) for presenting said generated pictogram to the user to notify the user of the state of the messaging unit.

3. A system according to claim 2, characterized in that the means for receiving messages destined for the user further comprise an e-mail box (5), a telephone answering machine (6), and/or means (7) for receiving faxes.

4. A system according to claim 1, 2, or 3, characterized in that the means for presenting the pictogram to the user comprise at least one of the elements selected from the group comprising: means (16) for printing the pictogram; a mobile telephone (17); a TV set (18); and a microcomputer (19).

5. A system for visually notifying the state of the messaging unit of a user, the system being characterized in that it comprises:
means (1) for monitoring the messaging unit, being connected to the various means (5, 6, 7) for receiving messages destined to the user;
analysis means (8) for analyzing the messages and their characteristics;
means (11) for generating a pictogram having attributes that are modifiable under the control of the analysis means as a function of the result of the analysis of the messages and their characteristics, the pictogram being presented in the form of a figure whose graphical characteristics contain meaningful information illustrating the state of the user's messaging unit; and
control means (14) for controlling means (15, 16, 17, 18) for presenting said generated pictogram to the user to notify the user of the state of the messaging unit.
